(19) United States
(12) Patent Application Publication
(10) Pub. No.: US 2021/0123594 A1
(43) Pub. Date: Apr. 29, 2021

(54) NOVELTY PROJECTOR LAMP

(71) Applicant: Clara D'Ambrosio, Fulshear, TX (US)

(72) Inventor: Clara D'Ambrosio, Fulshear, TX (US)

(21) Appl. No.: 16/666,410

(22) Filed: Oct. 29, 2019

(51) Int. Cl. F21V 33/00; F21V 23/02

(52) U.S. Cl. CPC F21V 33/0028; F21V 33/0056; F21V 23/023

(57) ABSTRACT

A novelty projector lamp device including a housing unit having an internal cavity for housing a projector member for displaying pre-programmed content. The housing unit including a lid member through which the projector member projects displayable pre-programmed content, a memory member for storing pre-programmed content for display by the projector member, an interface member for receiving content from an external source for display by the projector member and a plurality of control buttons for operating the device.

### FIELD OF THE INVENTION

Embodiments described herein generally relate to novelty devices, and more particularly to a projector lamp novelty device.

### BACKGROUND OF THE INVENTION

While positive phrases and affirmations are a powerful tool for reaffirming thoughts or behaviors, they tend to be elusive. Living by affirmations that one desires to uphold requires consistency as well as daily reminders throughout the day. Hence, there is a need in the art for an improved method for providing daily affirmations.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary front view of a novelty projector lamp device according to an embodiment of the present disclosure.

FIG. 2 shows an exemplary rear view of the novelty projector lamp device according to an embodiment of the present disclosure.

### SUMMARY OF THE INVENTION

Exemplary embodiments disclosed herein describe a novelty projector lamp device including a housing unit having an internal cavity for storing a projector member for displaying pre-programmed content. The housing unit including a lid member through which the projector member projects displayable pre-programmed content, a projecting memory member for storing pre-programmed content for display by the projector member, an interface member for receiving content from an external source for display by the projector member and a plurality of control buttons for controlling the operating of the device.

In some exemplary embodiments, the housing unit is shaped like a lamp.

In some exemplary embodiments, the projector member is a LED projector.

In some exemplary embodiments, the projector member is battery operated.

In some exemplary embodiments, the interface member includes a plurality of connectors, one of which receives content for display from an external source.

In some exemplary embodiments, the plurality of connectors are universal serial bus (USB) connectors.

In some exemplary embodiments, the housing unit includes an enclosure for storing an instruction manual.

In some exemplary embodiments, the housing unit includes a detachable power cord.

In some exemplary embodiments, the pre-programmed content includes at least of affirmations and personal mantras.

In some exemplary embodiments, the housing unit includes an enclosure for receiving a battery member and a memory card member.

In some exemplary embodiments, the housing unit includes a speaker member for playing audio.

### DETAILED DESCRIPTION

The present disclosure relates to a novelty projector lamp device for projecting positive thoughts, affirmations, mantras, etc., onto a surface, such as, for example, a ceiling. The device includes an enclosure for receiving a memory card which has stored thereon pre-programmed content for display by the projector. Moreover, the device may receive content for display from an external source which is connected to one of the device's USB connectors. The device provides a fun and interactive approach to providing daily affirmations.

Although the disclosure describes the content displayed by the device as affirmations, mantras, etc., any suitable or desirable type of content may be used with the device.

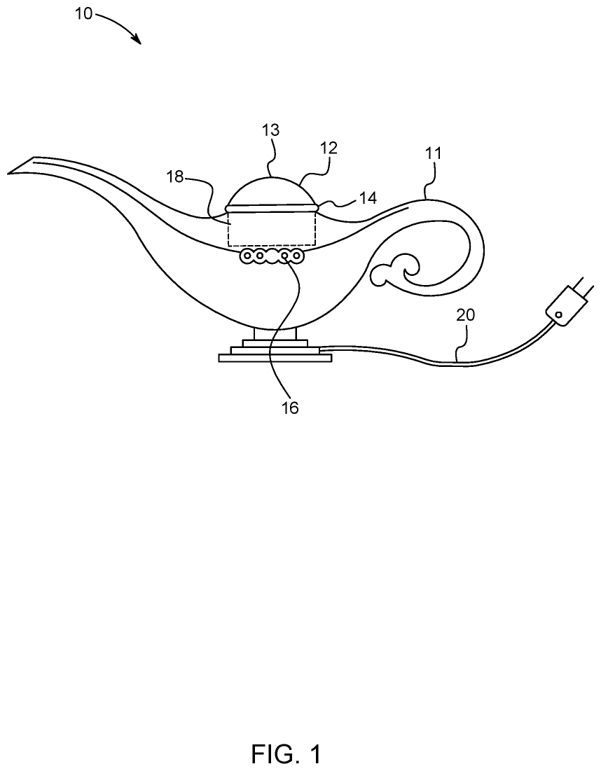

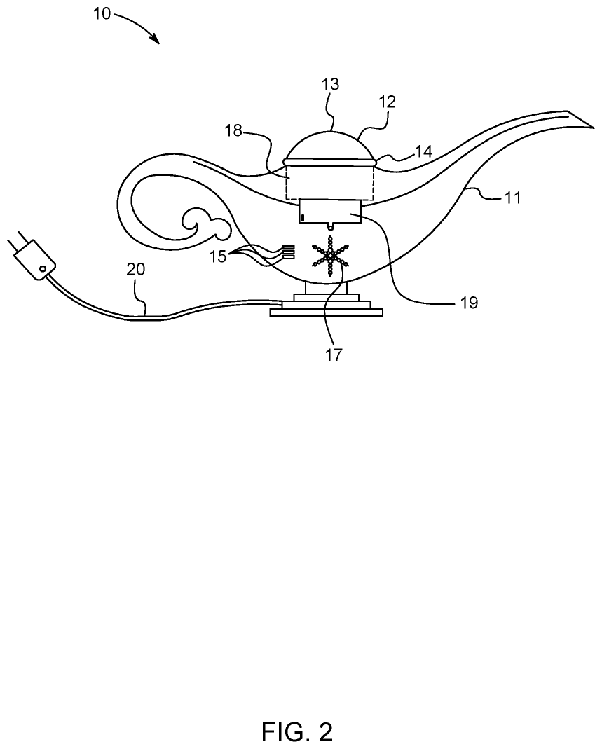

As illustrated in FIGS. 1-2, the novelty projector lamp device (“the device”) 10 includes a housing unit 11 having an internal cavity for storing a projector member 12. The housing unit 11 includes a projector member 12, a lid member 13, a projecting memory member 14, an interface member 15, a plurality of control buttons 16, a speaker member 17, an enclosure for storing an instruction manual 18, an enclosure for storing a battery member and a memory card member 19, and a detachable power cord 20.

The housing unit 11 may be shaped like a lamp, such as, for example, a genie lamp. The housing unit may be made of any suitable material, such as, for example, metal. The projector member 12 is enclosed in the housing unit. The projector member 12 is a miniature size and may be battery operated. Any suitable projector may be used for the projector member, and in a preferred embodiment, the projector member is a LED projector. The projector member 12 projects the content from a source. The source may be projecting memory member 14 or interface member 15.

The projector member 12 includes an enclosure for receiving a projecting memory member 14. The projecting memory member may be any suitable memory device, such as, for example, a secure digital (SD) card. The projecting memory member 14 may store pre-programmed content for display by the projector member. The projecting memory member is interchangeable, and the projector member 12 may be loaded with different projecting memory members. The pre-programmed content may include any suitable content, and in a preferred embodiment, the content includes affirmation, mantras, positive quotes, etc.

The interface member 15 may include a plurality of connectors which may interface to external sources, such as, for example, a mobile phone, a computer, etc. The connectors may include at least one universal serial bus (USB) connector and at least one of the connectors may receive content for display by projector member 12.

The lid member 13 is located at a top region of the housing unit and may be detached (i.e., removed) from the rest of the housing unit. The lid member includes an aperture through which the projecting lens of the projector member 12 projects an image of the content from the source. The device 10 may be positioned in any desired manner. In a preferred embodiment, the device is situated in an upright position, and the projecting lens is directed in a north direction and may project the images of the content on a ceiling surface.

The plurality of control buttons 16 control the operation of the device 10. The plurality of control buttons may include a power button to power the device on and off, a mode button to select the source of the content for display by the projector member 12, a track back button, a track forward button, a volume up button and a volume down button. The speaker member 17 plays audio. The speaker member 17 may be any suitable speaker.

The housing unit 11 includes an enclosure 18 for storing an instruction manual. Moreover, housing unit 11 includes an enclosure 19 for storing a battery member and a memory card memory. The battery member may power the projector member 12 and may be rechargeable. The memory card member may store additional content for display by the projector member 12. The housing unit 11 includes a detachable power cord 20 for providing power to the device when the power cord is attached to a power outlet.

In some exemplary embodiments, the device 10 includes a lighting member. The lighting member may be any suitable lighting, such as, for example, oil lighting.

In some exemplary embodiments, the housing unit 11 includes storage space in the internal cavity for storing objects.

In some exemplary embodiments, the device 10 includes a voice recorder.

The disclosed embodiments are not inclusive and many other modifications and variations will be apparent to someone of ordinary skill in the art with construction skills in the related arts. Together the descriptions and accompanying illustrations seek to provide an explanation of the basic principles of the embodiment and its application. It is therefore intended that the specification and embodiments be considered as exemplary only.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. An ornamental projector lamp device comprising:
a housing unit having an internal cavity for storing a projector member for displaying pre-programmed content, the housing unit is configured in a shape of a teapot lamp and includes a lid member through which the projector member projects displayable pre-programmed content, a projecting memory member for storing pre-programmed content for display by the projector member, an interface member for receiving content from an external source for display by the projector member and a plurality of control buttons for controlling the operating of the device, wherein the projector member is configured to be positioned in a manner that allows the pre-programmed content to be displayed on a ceiling.

2. (canceled)

3. The device of claim 1, wherein the projector member is a LED projector.

4. The device of claim 1, wherein the projector member is battery operated.

5. The device of claim 1, wherein the interface member includes a plurality of connectors, one of which receives content for display from an external source.

6. The device of claim 5, wherein at least one of the plurality of connectors is a universal serial bus (USB) connector.

7. The device of claim 1, wherein the housing unit includes an enclosure for storing an instruction manual.

8. The device of claim 1, wherein the housing includes a detachable power cord.

9. The device of claim 1, wherein the pre-programmed content includes at least of affirmations and personal mantras.

10. The device of claim 1, wherein the housing unit includes an enclosure for receiving a battery member and a memory card member.

11. The device of claim 1, wherein the housing unit includes a speaker member for playing audio.
